(19) United States
(12) Patent Application Publication
(10) Pub. No.: US 2010/0086786 A1
(43) Pub. Date: Apr. 8, 2010

(54) METHOD OF PRODUCING MULTILAYER COATING FILM

(75) Inventor: Kiyoshi ITOH, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: DAI NIPPON PRINTING CO., LTD., Shinjuku-ku (JP)

(21) Appl. No.: 12/573,370

(22) Filed: Oct. 5, 2009

(30) Foreign Application Priority Data
Oct. 6, 2008 (JP) 2008-259616

(51) Int. Cl. B32B 27/28; B32B 37/00; B32B 27/36; B32B 27/40; B32B 27/30

(52) U.S. Cl. 428/412; 156/239; 428/480; 428/423.1; 428/522

(57) ABSTRACT

Provided is a method of producing a multilayer coating film, the method including the steps of: turning multiple coating liquids into multiple layers in advance; and transferring the coating liquids turned into multiple layers onto a substrate, in which a mixing-preventing component that prevents two kinds of coating liquids which contact each other from mixing with each other is added to at least one of the two kinds of coating liquids in advance, and molecules of the mixing-preventing component are localized toward a vicinity of an interface between layers of the coating liquids so that the interface between layers is secured. The production method includes producing a multilayer coating film having good interlayer adhesiveness with ease and good productivity, by collectively applying multiple coating liquids without using a gelling agent or the like for modifying the viscosity of each coating liquid to be laminated.

### BACKGROUND OF THE INVENTION

1. Field of the Invention

The present invention relates to a method of producing a multilayer coating film, and more specifically, to a method of producing a multilayer coating film having good interlayer adhesiveness with ease and good productivity, the method including collectively applying multiple coating liquids.

2. Description of the Related Art

Conventionally, there has been known a multilayer coating mode with which multiple layers are formed on a running substrate by one application process, and the multilayer coating mode has been widely utilized in a coating process for a photographic film or the like. As illustrated in FIG. 1, a coating method according to the mode involves: extruding coating liquids A and B from multiple narrow slits in an application head 1; causing the liquids to flow down naturally by virtue of gravity on an inclined slide surface 2; and transferring the overlapping coating liquids A and B onto a running substrate 4 with a roll 3 to form a multilayer coating film.

Such a method is effective in aqueous coating liquids, and the following method has been known: multiple layers of halogenated emulsions each using gelatin as a binder are simultaneously applied, and are then cooled. The method intends to form a coating film by, for example, drying with hot air on the following condition: a multilayer film is caused to gel by utilizing the sol-gel transformation characteristic of gelatin so as to be in an ultrahigh-viscosity state, and hence, the occurrence of the mixing of layers is suppressed.

On the other hand, organic solvent-based coating liquids each have a lower surface tension than those of the aqueous coating liquids, so the organic solvent-based coating liquids are apt to diffuse and to mix with each other. In addition, no sol-gel transformation substances effective in the organic solvent-based coating liquids have been found. Therefore, in the case of the organic solvent-based coating liquids, the following method has been adopted: layers of the coating liquids are applied one by one, and are then dried. Because such a one-by-one application and drying method requires an enormous production cost and an extremely long production time, a method of forming multiple layers by one application process has been heretofore proposed for the organic solvent-based coating liquids as well.

For example, the following method has been proposed (see Japanese Examined Patent Publication No. Sho 63-20584): a viscosity-modifying component such as a thickener is added so that flowability at an interface between two contacting layers or the extent to which the layers mix with each other may be controlled. The method requires a certain amount of a thickener for viscosity modification. In addition, such an additive is generally a low-molecular-weight organic material, and is assumed to move in a layer, or across layers, during multilayer coating or after the formation of a laminate to reduce the mechanical characteristics or interlayer adhesiveness of the laminate; in some applications, the method has been inapplicable.

In addition, the following method has been proposed (see Japanese Patent Application Laid-open No. Hei 07-136578): two kinds of organic solvent-based coating liquids are used, and a surfactant is added to one of the coating liquids to control the surface tension of the coating liquid so that a substrate may be coated with multiple layers simultaneously in a state where an interface between two layers of the coating liquids is maintained.

However, the method also involves the same problems as those described above because the method includes the addition of a certain amount of the surfactant.

Further, the following method has been proposed (see Japanese Patent Application Laid-open No. Sho 61-74675). An electron beam-curable compound is added to at least one kind of two or more kinds of nonaqueous application liquids, and multiple layers of the application liquids are simultaneously applied. After that, the applied layers are irradiated with electron beams so as to be cured or thickened. Then, the layers are dried so that a multilayer coating film may be obtained.

However, the method involves the following problems: the step of irradiating the layers with the electron beams must be performed after the applying step before the application liquids diffuse or mix with each other, so the operations are complicated; in addition, a large apparatus is needed.

### SUMMARY OF THE INVENTION

The present invention has been made in view of such circumstances, and an object of the present invention is to provide a method of producing a multilayer coating film having good interlayer adhesiveness with ease and good productivity, the method including collectively applying multiple coating liquids without using a gelling agent or the like for modifying the viscosity of each coating liquid to be laminated.

The inventors of the present invention have made extensive studies with a view to achieving the object. As a result, the inventors have found that, when a small amount of a mixing-preventing component that prevents two kinds of coating liquids which contact each other from mixing with each other is added to at least one of the two kinds of coating liquids in advance, an interface between the coating liquids is secured, so a multilayer coating film having good interlayer adhesiveness can be produced with ease and good productivity. The present invention has been completed on the basis of such a finding.

That is, the present invention relates to the following items [1] to [8]:

[1] a method of producing a multilayer coating film, the method including the steps of: turning multiple coating liquids into multiple layers in advance; and transferring the coating liquids turned into multiple layers onto a substrate, in which a mixing-preventing component that prevents two kinds of coating liquids which contact each other from mixing with each other is added to at least one of the two kinds of coating liquids in advance, and molecules of the mixing-preventing component are localized toward a vicinity of an interface between layers of the coating liquids so that the interface between layers is secured;

[2] the method of producing a multilayer coating film according to the item [1], in which a solvent contained in each of the coating liquids includes an organic solvent;

[3] the method of producing a multilayer coating film according to the item [1], in which at least one of the following methods (1) and (2) is employed as a method of incorporating the mixing-preventing component into at least one of the two kinds of coating liquids which contact each other in advance: (1) a method involving adding in advance, to an upper layer coating liquid, a mixing-preventing component which has a larger specific gravity than a specific gravity of the coating liquid and which has a solubility parameter (SP value) differing from an SP value of a solvent contained in the coating liquid by 2 or less and from an SP value of a solvent contained in a lower layer coating liquid by more than 2; and (2) a method involving adding in advance, to the lower layer coating liquid, a mixing-preventing component which has a smaller specific gravity than a specific gravity of the coating liquid and which has an SP value differing from the SP value of the solvent contained in the coating liquid by 2 or less and from the SP value of the solvent contained in the upper layer coating liquid by more than 2;

[4] the method of producing a multilayer coating film according to the item [3], in which the method (2) is employed as the method of incorporating the mixing-preventing component into at least one of the two kinds of coating liquids which contact each other in advance;

[5] the method of producing a multilayer coating film according to the item [1], in which a content of the mixing-preventing component added to at least one of the two kinds of coating liquids which contact each other is 1 to 20 mass % with reference to a solid content of the coating liquid containing the mixing-preventing component;

[6] the method of producing a multilayer coating film according to the item [1], in which: an inclined slide surface is used when the multiple coating liquids are turned into multiple layers in advance; and the slide surface has an inclination angle of 5 to 40° with respect to a horizontal direction;

[7] a multilayer coating film obtained by the method of producing a multilayer coating film according to any one of the items [1] to [6]; and

[8] a method of coating a substrate with multiple layers, the method including: turning multiple coating liquids into multiple layers in advance; and transferring the coating liquids turned into multiple layers onto the substrate to form a multilayer coating film, in which a mixing-preventing component that prevents two kinds of coating liquids which contact each other from mixing with each other is added in advance to at least one of the two kinds of coating liquids, and molecules of the mixing-preventing component are localized toward a vicinity of an interface between layers of the coating liquids so that the interface between layers is secured.

According to the present invention, there is provided a method of producing a multilayer coating film without the use of a large amount of a gelling agent or the like for modifying the viscosity, in which a small amount of a mixing-preventing component that prevents two kinds of coating liquids which contact each other from mixing with each other is added in advance to at least one of the two kinds of coating liquids, an interface between the coating liquids is secured, so a multilayer coating film having good interlayer adhesiveness can be produced with ease and good productivity.

### BRIEF DESCRIPTION OF THE DRAWINGS

FIG. 1 is a conceptual view illustrating an example of an apparatus for producing a multilayer coating film of the present invention.

FIG. 2 is a photograph of a two-layer coating film obtained in Example 1 taken with a scanning electron microscope.

### DETAILED DESCRIPTION OF THE PREFERRED EMBODIMENTS

Hereinafter, a method of producing a multilayer coating film of the present invention is described in detail. It should be noted that, although the following description is given by taking a method of producing a simultaneous multilayer coating film formed of two layers as an example, the present invention is not limited to the production of a multilayer coating film formed of two layers, and is applicable to the production of a simultaneous multilayer coating film formed of three or more layers as well.

The method of producing a multilayer coating film of the present invention involves: turning coating liquid A (upper layer coating liquid) and coating liquid B (lower layer coating liquid) into multiple layers in advance; and transferring the coating liquids turned into multiple layers onto a substrate to produce the multilayer coating film.

Although a method of turning the upper layer coating liquid A and lower layer coating liquid B into multiple layers in advance is not particularly limited, examples of the method include (1) a method involving turning the coating liquids into multiple layers on an inclined slide surface, (2) a method involving turning the coating liquids into multiple layers on a horizontal plane, (3) a method involving turning the coating liquids into multiple layers on a circular cylinder, and (4) a method involving turning the coating liquids into multiple layers on an inclined paraboloid. Of those, the method (1) is preferably used in ordinary cases.

The present invention is as follows: a mixing-preventing component that prevents the two kinds of coating liquids which contact each other from mixing with each other is added in advance to at least one of the two kinds of coating liquids without the use of a gelling agent or the like, and the molecules of the mixing-preventing component are localized toward the vicinity of an interface between the coating liquids which contact each other to prevent the coating liquids from mixing with each other, so the diffusion and mixing of the upper layer coating liquid and lower layer coating liquid do not occur, and the coating liquids can be transferred onto the substrate while a multilayer structure is maintained.

In this case, a solvent contained in each of the multiple coating liquids is preferably an organic solvent in terms of the effect of the present invention.

A gelling agent or thickener typically used for realizing the lamination of multiple layers must be added in a large amount in many cases in order that its effect may be obtained, though the amount varies depending on the composition of the coating liquid to which the gelling agent or thickener is added. As a result, for example, the following fear arises: the gelling agent or thickener moves in a layer, or across layers, after the lamination so as to precipitate on an interface between layers or the surface of a layer in a large amount so that the mechanical strength or interlayer adhesiveness of the multilayer coating film may decrease. In addition, the number of materials that have been proposed at present serving as gelling agents or thickeners effective for organic solvent-based inks targeted by the present invention is not very large, though various kinds of materials serving as gelling agents or thickeners for aqueous inks and alcohol-based coating liquids have been proposed.

In the present invention, the viscosity of each of the coating liquids is not modified by using such gelling agent or the like, but the molecules of the mixing-preventing component that prevents the coating liquids from mixing with each other are localized toward the vicinity of an interface between the coating liquids to prevent the coating liquids from mixing with each other at the interface. A ratio of the mixing-preventing component to the total solid content is small, and the molecules of the component are localized toward the vicinity of the interface, so a laminated structure can be formed with no significant influence on the function of the entirety of the laminated structure.

In the present invention, the content of the mixing-preventing component to be added to at least one of the two kinds of coating liquids which contact each other has only to be 1 to 20 mass %, or is preferably 3 to 18 mass %, or more preferably 5 to 15 mass % with reference to the solid content of the coating liquid containing the mixing-preventing component in order that the diffusion and mixing of the coating liquids at the interface may be prevented.

In the present invention, one or both of the following methods (1) and (2) can be employed as a method of adding in advance the mixing-preventing component into at least one of the two kinds of coating liquids which contact each other: (1) a method involving adding in advance, to the upper layer coating liquid, a mixing-preventing component which has a larger specific gravity than that of the coating liquid and which has a solubility parameter (SP value) differing from that of the solvent contained in the coating liquid by 2 or less (preferably 1.9 or less, or more preferably 1.8 or less) and from that of the solvent contained in the lower layer coating liquid by more than 2 (preferably more than 2.1, or more preferably more than 2.2); or (2) a method involving adding in advance, to the lower layer coating liquid, a mixing-preventing component which has a smaller specific gravity than that of the coating liquid and which has an SP value differing from that of the solvent contained in the coating liquid by 2 or less (preferably 1.9 or less, or more preferably 1.8 or less) and from that of the solvent contained in the upper layer coating liquid by more than 2 (preferably more than 2.1, or more preferably more than 2.2).

In each of the methods, a state where a difference between the SP value of the solvent contained in a coating liquid and the SP value of the mixing-preventing component added to the coating liquid is 2 or less means that the solvent is a good solvent for the mixing-preventing component; meanwhile, a state where the difference between the SP values is more than 2 means that the solvent is a poor solvent for the mixing-preventing component.

That is, in the method (1), the solvent contained in the upper layer coating liquid is a good solvent for the mixing-preventing component added to the coating liquid, so the mixing-preventing component stably dissolves in the upper layer coating liquid. However, the solvent contained in the lower layer coating liquid is a poor solvent for the mixing-preventing component, so the mixing-preventing component is hardly soluble or insoluble in the lower layer coating liquid. Moreover, the specific gravity of the mixing-preventing component is larger than that of the upper layer coating liquid, so the molecules of the mixing-preventing component are localized toward, and precipitated in, the vicinity of the interface between the upper layer coating liquid and the lower layer coating liquid. As a result, the component prevents the diffusion and mixing of the two kinds of coating liquids, and the interface can be stably secured. It should be noted that the molecules of the mixing-preventing component may be localized like a continuous film toward the vicinity of the interface, or may be localized like islands instead of a continuous film.

On the other hand, in the method (2), the solvent contained in the lower layer coating liquid is a good solvent for the mixing-preventing component added to the coating liquid, so the mixing-preventing component stably dissolves in the lower layer coating liquid. However, the solvent contained in the upper layer coating liquid is a poor solvent for the mixing-preventing component, so the mixing-preventing component is hardly soluble or insoluble in the upper layer coating liquid. Moreover, the specific gravity of the mixing-preventing component is smaller than that of the lower layer coating liquid, so the molecules of the mixing-preventing component are localized toward, and precipitated in, the vicinity of the interface between the lower layer coating liquid and the upper layer coating liquid. As a result, the component prevents the diffusion and mixing of the two kinds of coating liquids, and the interface can be stably secured.

In the present invention, the method (1) may be adopted as the method of incorporating the mixing-preventing component into at least one of the two kinds of coating liquids which contact each other in advance, the method (2) may be adopted, or both the methods (1) and (2) may be adopted; the method (2) is particularly preferred because the method reduces the extent to which one is concerned about, for example, an increase in viscosity of the coating liquid itself, and improves the productivity of the multilayer coating film.

Examples of the mixing-preventing component added to the upper layer coating liquid and having a larger specific gravity than that of the main component in the coating liquid in the method (1) include a polyacrylate, a polyacrylamide, and a polyolefin.

On the other hand, examples of the mixing-preventing component added to the lower layer coating liquid and having a smaller specific gravity than that of the main component in the coating liquid in the method (2) include a polyester, a polyethylene, a polypropylene, and a polystyrene. The SP value of the component can be appropriately adjusted depending on, for example, the molecular weight of the component.

Next, examples of the solvents that are generally used for each of the coating liquids include toluene (SP value 8.9), xylene (SP value 8.7), methyl ethyl ketone (SP value 9.3), methyl isobutyl ketone (SP value 8.4), cyclohexanone (SP value 9.9), acetone (SP value 9.8), ethyl acetate (SP value 9.1), tetrahydrofuran (SP value 9.2), ethyl cellosolve (SP value 9.9), propylene glycol monomethyl ether (SP value 10.2), ethanol (SP value 12.7), n-propanol (SP value 12.1), isopropanol (SP value 11.5), isobutanol (SP value 11.0), and hexane (SP value 7.2).

The mixing-preventing component, and the solvents used in the upper layer coating liquid and the lower layer coating liquid are selected in consideration of, for example, the specific gravity and SP value of the mixing-preventing component, and the SP values of the solvents. It should be noted that taking the solubility of a binder (film-forming component) as well as those described above into consideration is of importance when a solvent is selected.

The SP values are each a value determined from the following equation:

(SP value)²=CED=ΔE/V=(ΔH−RT)/V=d(ΔH−RT)/M

where ΔE represents evaporation energy (cal/ml), V represents a molar volume (cm³/mol), ΔH represents evaporative latent heat (cal/mol), R represents a gas constant (=1.987 cal/K≠mol), d represents a density (g/ml), M represents a gram molecular weight (g/mol), and T represents an absolute temperature (K). The SP values of the solvents were cited from “Rubber Industry Handbook (fourth edition).”

Thus, the diffusion and mixing of the upper layer coating liquid and the lower layer coating liquid do not occur at the interface between the coating liquids, and the coating liquids can be transferred onto the substrate while a multilayer structure is maintained.

(Main Component of Coating Liquid)

The main component of each coating liquid in the present invention is not particularly limited as long as the main component is a resin which: dissolves in a solvent used in the coating liquid; and has film-forming property. For example, a thermoplastic resin such as a polyester-based resin, a polyester urethane-based resin, an acrylic resin, a denatured acrylic resin, or a polycarbonate can be used. One kind of them may be used alone, or two or more kinds of them may be used in combination. Each of those thermoplastic resins has a weight-average molecular weight of preferably several tens of thousand to several millions, or more preferably 30,000 to 500,000.

In addition, in the present invention, an active energy ray-curable compound can also be used as the main component of each coating liquid.

The active energy ray-curable compound is a compound having an energy quantum in an electromagnetic wave or charged particle beam, that is, a compound the molecules of which crosslink and cure by being irradiated with ultraviolet rays, electron beams, or the like. Such active energy ray-curable oligomers and active energy ray-curable monomers as described below can be used as the active energy ray-curable compound.

Examples of the active energy ray-curable oligomers include polyester acrylate-, epoxy acrylate-, urethane acrylate-, polyether acrylate-, polybutadiene acrylate-, and silicone acrylate-based oligomers.

Here, the polyester acrylate-based oligomer can be obtained by, for example, esterifying a hydroxyl group of a polyester oligomer having hydroxyl groups at both of its terminals obtained by the condensation of a polyhydric alcohol with (meth)acrylic acid or esterifying the hydroxyl group at a terminal of an oligomer obtained by adding an alkylene oxide to a polyvalent carboxylic acid with (meth)acrylic acid. The epoxy acrylate-based oligomer can be obtained by, for example, causing (meth)acrylic acid to react with the oxirane ring of a bisphenol-type epoxy resin or novolac-type epoxy resin having a relatively low molecular weight (for example, less than 5,000) to esterify the ring. In addition, a carboxyl-denatured epoxy acrylate oligomer obtained by partially denaturing the epoxy acrylate-based oligomer with a dibasic carboxylic anhydride can also be used. The urethane acrylate-based oligomer can be obtained by, for example, esterifying a polyurethane oligomer obtained by a reaction between a polyether polyol or polyester polyol and a polyisocyanate with (meth)acrylic acid. The polyol acrylate-based oligomer can be obtained by esterifying a hydroxyl group of a polyether polyol with (meth)acrylic acid.

The weight-average molecular weight of each of the above oligomers is selected from the range of preferably 500 to 100,000, more preferably 1,000 to 70,000, or still more preferably 3,000 to 40,000 in terms of a standard polystyrene measured by a gel permeation chromatography (GPC) method.

One kind of the oligomers may be used alone, or two or more kinds of them may be used in combination.

On the other hand, examples of the active energy ray-curable monomers include 1,4-butanediol di(meth)acrylate, 1,6-hexanediol di(meth)acrylate, neopentyl glycol di(meth)acrylate, polyethylene glycol di(meth)acrylate, neopentyl glycol adipate di(meth)acrylate, hydroxypivalate neopentyl glycol di(meth)acrylate, dicyclopentanyl di(meth)acrylate, caprolactone-modified dicyclopentenyl di(meth)acrylate, ethyleneoxide-modified phosphate di(meth)acrylate, allylated cylclohexyl di(meth)acrylate, isocyanurate di(meth)acrylate, dimethyloltricyclodecane di(meth)acrylate, trimethylolpropane tri(meth)acrylate, dipentaerythritol tri(meth)acrylate, propionate-modified dipentaerythritol tri(meth)acrylate, pentaerythritol tri(meth)acrylate, propionoxide-modified trimethylolpropane tri(meth)acrylate, tris(acryloxyethyl) isocyanurate, propionate-modified dipentaerythritol penta(meth)acrylate, dipentaerythritol hexa(meth)acrylate, and caprolactone-modified dipentaerythritol hexa(meth)acrylate. One kind of those monomers may be used alone, or two or more kinds of them may be used in combination.

Further, in addition to the active energy ray-curable compounds, a photopolymerization initiator may also be used. Examples of the photopolymerization initiator include benzoine, benzoine methyl ether, benzoine ethyl ether, benzoine isopropyl ether, benzoine-n-butyl ether, benzoine isobutyl ether, acetophenone, dimethylaminoacetophenone, 2,2-dimethoxy-2-phenylacetophenone, 2,2-dimethoxy-1,2-diphenylethane-1-one, 2,2-diethoxy-2-phenylacetophenone, 2-hydroxy-2-methyl-1-phenylpropane-1-one, 1-hydroxycyclohexyl phenyl ketone, 2-methyl-1-[4-(methylthio)phenyl]-2-morphorinopropane-1-one, 4-(2-hydroxyethoxy)phenyl-2(hydroxy-2-propyl) ketone, benzophenone, p-phenylbenzophenone, 4,4′-diethylaminobenzophenone, dichlorobenzophenone, 2-methylanthraquinone, 2-ethylanthraquinone, 2-tert-butylanthraquinone, 2-aminoanthraquinone, 2-methylthioxanthone, 2-ethylthioxanthone, 2-chlorothioxanthone, 2,4-dimethylthioxanthone, 2,4-diethylthioxanthone, benzyl dimethyl ketal, acetophenone dimethyl ketal, p-dimethylamine benzoate, and oligo(2-hydroxy-2-methyl-1-[4-(1-propenyl)phenyl]propanone). One kind of them may be used alone, or two or more kinds of them may be used in combination. The amount in which the photopolymerization initiator is used may be appropriately selected in accordance with the kind of the active energy ray-curable compound to be used; the photopolymerization initiator is typically used in an amount ranging from 0.001 to 0.5 times the mass of the active energy ray-curable compound.

(Other Additives)

Any one of the various additives may be further added to each of the coating liquids. Examples of the additives include an antioxidant, a UV absorber, a light stabilizer, a leveling agent, and a defoaming agent.

It should be noted that the solid concentration and viscosity of each coating liquid in the present invention are not particularly limited as long as the concentration and the viscosity are such that the substrate can be coated with the coating liquid, and the concentration and the viscosity can be appropriately selected in accordance with circumstances.

(Substrate)

A substrate to which the coating liquids are applied is not particularly limited, and can be appropriately selected in accordance with the applications of a member having the multilayer coating film. Particularly when the multilayer coating film according to the present invention is used in an optical member, a film appropriately selected from known plastic films can be used as the substrate of the optical film. Examples of such plastic films include polyester films such as polyethylene terephthalate, polybutylene terephthalate, and polyethylene naphthalate; polyethylene films; polypropylene films; cellophane; diacetylcellulose films; triacetylcellulose films; acetylcellulose butylate films; polyvinyl chloride films; polyvinylidene chloride films; polyvinyl alcohol films; ethylene/vinyl acetate copolymer films; polystyrene films; polycarbonate films; polymethylpentene films; polysulfone films; polyetheretherketone films; polyethersulfone films; polyetherimide films; polyimide films; fluororesin films; polyamide films; acrylic resin films; norbornene-based resin films; and cycloolefin resin films.

Those substrates may be transparent, or may be semitransparent, and may be colored, or may be colorless; an appropriate substrate may be selected in accordance with the applications of the multilayer coating film. For example, when the multilayer coating film is used for protecting a liquid crystal display, a colorless, transparent film is preferable.

The thickness of any such substrate is not particularly limited, and is appropriately selected in accordance with circumstances; the thickness falls within the range of typically 15 to 250 μm, or preferably 30 to 200 μm. In addition, one surface or both surfaces of the substrate can be subjected to a surface treatment by, for example, an oxidation method or irregularity method as desired for the purpose of improving adhesiveness between a surface and a layer provided on the surface. Examples of the above oxidation method include a corona discharge treatment, a chromic acid treatment (wet), a flame treatment, a hot air treatment, and an ozone/UV irradiation treatment. In addition, examples of the irregularity method include a sandblast method and a solvent treatment method. Those methods for the surface treatment are appropriately selected in accordance with the kind of the substrate; in general, the corona discharge treatment method is preferably employed in terms of, for example, its effect and operability.

(Formation of Multilayer Coating Film)

As described above, a method involving turning multiple coating liquids into multiple layers in advance and transferring the coating liquids turned into multiple layers onto a substrate is adopted in the present invention.

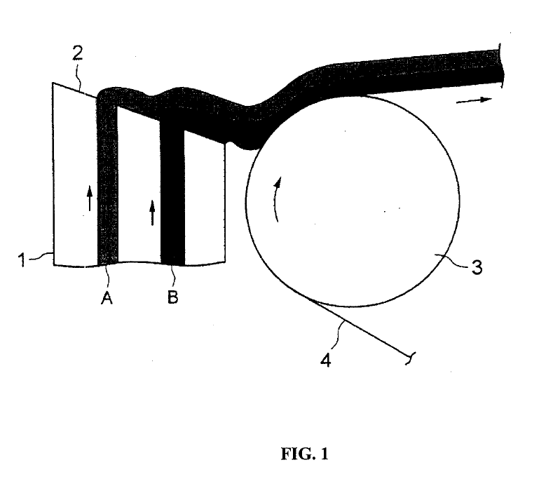

In the case where an inclined slide surface is utilized when the coating liquids are turned into multiple layers, such a slide coater as illustrated in FIG. 1 is a preferable example of a product having the inclined slide surface for causing the coating liquids to flow.

The slide surface has an inclination angle of preferably 5 to 40°, more preferably 10 to 35°, or still more preferably 15 to 35° with respect to a horizontal direction. In addition, a distance between the center of an orifice for ejecting a coating liquid onto the slide surface and the center of an adjacent orifice for ejecting a coating liquid is preferably 8 to 30 cm, more preferably 10 to 28 cm, or still more preferably 12 to 26 cm. Further, a distance between the center of the ejection orifice closest to a site where the coating liquids are transferred onto the substrate out of the multiple orifices for ejecting the coating liquids onto the slide surface and the substrate is preferably 2 to 14 cm, more preferably 3 to 12 cm, or still more preferably 4 to 11 cm. Particularly when a slide coater designed as described above is used, the effect of the present invention tends to appear saliently.

Hereinafter, an example of a method of turning the coating liquids into multiple layers is described in detail with reference to the slide coater of FIG. 1.

The coating liquids A and B are each extruded from two slit-like ejection orifices in an application head 1, and are then caused to flow down naturally by virtue of gravity on a slide surface 2, which is inclined, so that the coating liquids A and B may be turned into multiple layers. The coating liquids turned into multiple layers (coating films) are transferred onto a substrate 4 which is running with a roll 3.

When the film-forming component in each coating liquid is such a thermoplastic resin as described above, the multilayer coating film can be formed by: coating on top of the substrate with multiple layers of the coating liquids as described above; and heating and drying the coating liquids as appropriate. The temperature at which the coating liquids are heated and dried is typically 40 to 150° C., preferably 50 to 120° C., or more preferably 60 to 90° C. The time period for which the coating liquids are heated and dried, which is not particularly limited, is typically about 1 to 5 minutes.

On the other hand, when the film-forming component in each coating liquid is such an active energy ray-curable compound as described above, the multilayer coating film is formed by: heating and drying the coating liquids as described above; and irradiating the dried products with active energy rays to cure the dried products. Examples of the active energy rays include ultraviolet rays and electron beams. The above ultraviolet rays can be obtained by using, for example, a high-pressure mercury lamp, a fusion H lamp, or a xenon lamp while the electron beams can be obtained by using, for example, an electron beam accelerator. Of the active energy rays, the ultraviolet rays are particularly suitable. It should be noted that, when the electron beams are used, a cured film can be obtained without adding any photopolymerization initiator.

When the active energy rays are the ultraviolet rays, the quantity of the ultraviolet rays is preferably about 50 to 200 mJ/cm².

The multilayer coating film thus formed has a thickness of typically about 0.1 μm to 10 μm, or preferably 1 μm to 5 μm, and is such that the layers formed of the respective coating liquids are separated from each other.

The separated-layer structure can be observed with, for example, an interfacial ultraviolet and visible spectrophotometer utilizing slab optical waveguide spectrometry. In addition, the stricture can be observed by investigating its section with a scanning electron microscope (SEM) or optical microscope as well.

### EXAMPLES

Next, the present invention is described in more detail by way of examples. However, the present invention is by no means limited by those examples.

### Production Example 1

45 g of a polymethyl methacrylate (manufactured by KANTO CHEMICAL CO., INC., SP value 9.1) and 65 g of methyl isobutyl ketone (manufactured by KANTO CHEMICAL CO., INC., SP value 8.4) were mixed. Thus, a transparent acrylic resin-based solution (coating liquid 1) was obtained.

### Production Example 2

49.5 g of a polycarbonate (manufactured by Acros Organics, SP value 10.8), 5.5 g of an amorphous polyester “VYLON 550” (mixing-preventing component, manufactured by Toyobo Co., Ltd., SP value 10.7), and 45 g of toluene (manufactured by KANTO CHEMICAL CO., INC., SP value 8.9) were mixed. Thus, a transparent polycarbonate-based solution (coating liquid 2; specific gravity of the polycarbonate=1.2, specific gravity of the amorphous polyester=less than 1.2) was obtained.

### Production Example 3

55 g of a polycarbonate (manufactured by Acros Organics, SP value 10.8) and 45 g of toluene (manufactured by KANTO CHEMICAL CO., INC.) were mixed. Thus, a transparent polycarbonate-based solution (coating liquid 3) was obtained.

### Production Example 4

50.3 g of a polymethyl methacrylate (manufactured by KANTO CHEMICAL CO., INC., SP value 9.1), 6.7 g of an amorphous polyester “Elitel UE” (mixing-preventing component, manufactured by Unitika Ltd., SP value 10.9), and 43 g of propylene glycol monomethyl ether (manufactured by KANTO CHEMICAL CO., INC., SP value 10.2) were mixed. Thus, a transparent acrylic resin-based solution (coating liquid 4; specific gravity of the polymethyl methacrylate=1.2, specific gravity of the amorphous polyester=less than 1.2) was obtained.

### Production Example 5

51 g of a silicone-denatured acrylic resin (manufactured by Soken Chemical & Engineering Co., Ltd., assumed SP value 8), 4 g of an amorphous polyester “VYLON 550” (mixing-preventing component, manufactured by Toyobo Co., Ltd.), and 45 g of xylene (manufactured by KANTO CHEMICAL CO., INC., SP value 8.7) were mixed. Thus, a transparent acrylic resin-based solution (coating liquid 5; specific gravity of the amorphous polyester is less than one of the silicone-denatured acrylic resin) was obtained.

### Production Example 6

55 g of a polycarbonate (manufactured by Acros Organics, SP value 10.8) and 45 g of methyl isobutyl ketone (manufactured by KANTO CHEMICAL CO., INC.) were mixed by warming the solution to 50° C. due to slow solubility. Thus, a transparent polycarbonate-based solution (coating liquid 6) was obtained.

Table 1 below summarizes details about Production Examples 1 to 6 described above.

TABLE 1

| | | | | Kind of mixing- | | Content of mixing- |
|---|---|---|---|---|---|---|
| | Kind of | | | preventing | Solid | preventing component |
| | coating | Kind of solvent | Kind of | component | concentration | in solid content |
| | liquid | [SP value] | binder resin | [SP value] | (mass %) | (mass %) |
| Production | Coating | Methyl isobutyl ketone | Polymethyl | — | 41 | — |
| Example 1 | liquid 1 | [8.4] | methacrylate | | | |
| Production | Coating | Toluene | Polycarbonate | Amorphous | 55 | 10.0 |
| Example 2 | liquid 2 | [8.9] | | polyester A | | |
| | | | | [10.7] | | |
| Production | Coating | Toluene | Polycarbonate | — | 55 | — |
| Example 3 | liquid 3 | [8.9] | | | | |
| Production | Coating | Propylene glycol | Polymethyl | Amorphous | 57 | 11.8 |
| Example 4 | liquid 4 | monomethyl ether | methacrylate | polyester B | | |
| | | [10.2] | | [10.9] | | |
| Production | Coating | Xylene | Silicone-denatured | Amorphous | 55 | 7.3 |
| Example 5 | liquid 5 | [8.7] | acrylic resin | polyester A | | |
| | | | | [10.7] | | |
| Production | Coating | Methyl isobutyl ketone | Polycarbonate | — | 55 | — |
| Example 6 | liquid 6 | [8.4] | | | | |

an amorphous polyester A: “VYLON 245”, manufactured by Toyobo Co., Ltd.
an amorphous polyester B: “Elitel UE”, manufactured by Unitika Ltd.

### Example 1

The coating liquid 1 prepared in Production Example 1 was used as an upper layer coating liquid (coating liquid A), and the coating liquid 2 prepared in Production Example 2 was used as a lower layer coating liquid (coating liquid B). The on top portion of a polyethylene terephthalate film “COSMOSHINE (registered trademark) A4100” having a thickness of 100 μm (manufactured by Toyobo Co., Ltd.) was coated with the coating liquids by using the slice coater illustrated in FIG. 1 (an inclination angle of 25° with respect to a horizontal direction; a distance between the center of an orifice for ejecting a coating liquid onto the slide surface and the center of an adjacent orifice for ejecting a coating liquid is 8 cm; a distance between the center of the ejection orifice closest to a site where the coating liquids are transferred onto the substrate out of the multiple orifices for ejecting the coating liquids onto the slide surface and the substrate is preferably 10 cm.). After the coating, the coating liquids were dried in an oven at 80° C. for 1 minute. Thus, a two-layer coating film was formed.

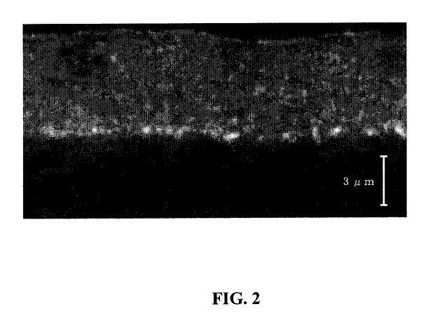

The section of the two-layer coating film was observed with a scanning electron microscope (SEM). As a result, a good laminated structure was observed. FIG. 2 illustrates a photograph of the section of the two-layer coating film taken with the SEM.

### Example 2

The coating liquid 6 prepared in Production Example 6 was used as a first layer coating liquid to serve as the uppermost layer, the coating liquid 5 prepared in Production Example 5 was used as an intermediate layer coating liquid, and the coating liquid 4 prepared in Production Example 4 was used as a lowermost layer coating liquid. The on top portion of a polyethylene terephthalate film “COSMOSHINE (registered trademark) A4100” having a thickness of 100 μm (manufactured by Toyobo Co., Ltd.) was coated with the coating liquids by using a slide coater for three-layer coating (an inclination angle of 25° with respect to a horizontal direction; a distance between the center of an orifice for ejecting a coating liquid onto the slide surface and the center of an adjacent orifice for ejecting a coating liquid is 8 cm; a distance between the center of the ejection orifice closest to a site where the coating liquids are transferred onto the substrate out of the multiple orifices for ejecting the coating liquids onto the slide surface and the substrate is preferably 10 cm.). After the coating, the coating liquids were dried in an oven at 80° C. for 1 minute. Thus, a three-layer coating film was formed.

The section of the three-layer coating film was observed with a scanning electron microscope (SEM). As a result, a good laminated structure was observed between two arbitrary adjacent layers.

### Comparative Example 1

The coating liquid 1 prepared in Production Example 1 was used as an upper layer coating liquid (coating liquid A), and the coating liquid 3 prepared in Production Example 3 was used as a lower layer coating liquid (coating liquid B). The on top of a polyethylene terephthalate film “COSMOSHINE (registered trademark) A4100” having a thickness of 100 μm (manufactured by Toyobo Co., Ltd.) was coated with the coating liquids by using the slide coater illustrated in FIG. 1 (an inclination angle of 25° with respect to a horizontal direction; a distance between the center of an orifice for ejecting a coating liquid onto the slide surface and the center of an adjacent orifice for ejecting a coating liquid is 8 cm; a distance between the center of the ejection orifice closest to a site where the coating liquids are transferred onto the substrate out of the multiple orifices for ejecting the coating liquids onto the slide surface and the substrate is preferably 10 cm.). After the coating, the coating liquids were dried in an oven at 80° C. for 1 minute. Thus, a coating film was formed.

The section of the coating film was observed with a scanning electron microscope (SEM). As a result, two layers were mixed, and hence, a laminated structure was not confirmed.

### INDUSTRIAL APPLICABILITY

According to the method of the present invention, a multilayer coating film can be produced with ease and good productivity by adding a small amount of the mixing-preventing component without incorporating a gelling agent or the like, which adversely affects the various physical properties of the film, for modifying the viscosity of each coating liquid. Therefore, the employment of the method enables the production of a multilayer film such as an optical film with high productivity without involving reductions in various physical properties of the film.

The disclosure of the priority document, JP 2008-259616, filed in Japan on Oct. 6, 2008, is incorporated by reference herein in its entirety.

### DESCRIPTION OF SYMBOLS

1: application head
2: slide surface
3: roll
4: substrate
A: upper layer coating liquid
B: lower layer coating liquid

What is claimed is:

1. A method of producing a multilayer coating film, the method comprising
laminating a first coating liquid and a second coating liquid to form a multilayered coating; and
transferring the multilayered coating onto a substrate, wherein
at least one of the first coating liquid and the second coating liquid comprises a mixing-preventing component that prevents mixing in the multilayered coating of the first coating liquid and the second coating liquid; and
molecules of the mixing-preventing component in the multilayered coating are localized toward a vicinity of an interface between the first coating liquid and the second coating liquid.

2. The method according to claim 1, wherein each of the first coating liquid and the second coating liquid comprises an organic solvent.

3. The method according to claim 1,
wherein the multilayered coating on the substrate comprises a lower layer and an upper layer, where
the lower layer is closer to the substrate than the upper layer,
the lower layer comprises the first coating liquid, and
the upper layer comprises the second coating liquid;
wherein the method further comprises, before forming the multilayered coating, adding the mixing-preventing component to the second coating liquid; and
wherein a specific gravity of the mixing-preventing component is larger than a specific gravity of the second coating liquid;
a solubility parameter of the mixing-preventing component differs from a solubility parameter of a solvent contained in the second coating liquid by 2 or less; and
the solubility parameter of the mixing-preventing component differs from a solubility parameter of a solvent contained in the first coating liquid by more than 2.

4. The method according to claim 1,
wherein the multilayered coating on the substrate comprises a lower layer and an upper layer, where
the lower layer is closer to the substrate than the upper layer,
the lower layer comprises the first coating liquid, and
the upper layer comprises the second coating liquid;
wherein the method further comprises, before forming the multilayered coating, adding the mixing-preventing component to the first coating liquid; and
wherein a specific gravity of the mixing-preventing component is smaller than a specific gravity of the first coating liquid;
a solubility parameter of the mixing-preventing component differs from a solubility parameter of a solvent contained in the first coating liquid by 2 or less; and
the solubility parameter of the mixing-preventing component differs from a solubility parameter of a solvent contained in the second coating liquid by more than 2.

5. The method according to claim 3, wherein a content of the mixing-preventing component in the second coating liquid is in a range of from 1 to 20 mass % with reference to a total content of solids dissolved in the second coating liquid.

6. The method according to claim 4, wherein a content of the mixing-preventing component in the first coating liquid is in a range of from 1 to 20 mass % with reference to a total content of solids dissolved in the first coating liquid.

7. The method according to claim 1, wherein
the multilayered coating is formed on a slide surface; and
the slide surface has an inclination angle of 5° to 40° with respect to a horizontal direction.

8. The method according to claim 1, wherein the first coating liquid does not contain a gelling agent.

9. The method according to claim 1, wherein the second coating liquid does not contain a gelling agent.

10. The method according to claim 2, wherein the organic solvent comprises at least one selected from the group consisting of toluene, xylene, methyl ethyl ketone, methyl isobutyl ketone, cyclohexanone, acetone, ethyl acetate, tetrahydrofuran, ethyl cellosolve, propylene glycol monomethyl ether, ethanol, n-propanol, isopropanol, isobutanol, and hexane.

11. The method according to claim 3, wherein the mixing-preventing component is selected from the group consisting of polyacrylates, polyacrylamides and polyolefins.

12. The method according to claim 4, wherein the mixing-preventing component is selected from the group consisting of polyesters, polyethylenes, polypropylenes and polystyrenes.

13. The method according to claim 1, wherein the first coating liquid and the second coating liquid contain resins independently selected from the group consisting of thermoplastic resins having a weight-average molecular weight in a range of from 30,000 to 500,000.

14. The method according to claim 1, wherein the thermoplastic resins are selected from the group consisting of polyester-based resins, polyester urethane-based resins, acrylic resins, denatured acrylic resins and polycarbonate resins.

15. The method according to claim 1, wherein the substrate comprises a plastic.

16. The method according to claim 1, further comprising heating the multilayered coating on the substrate to a temperature in a range of from 40° C. to 150° C.

17. The method according to claim 1, further comprising irradiating the multilayered coating on the substrate with active energy rays.

18. A method of coating a substrate with multiple layers, the method comprising
laminating a first coating liquid and a second coating liquid to form a multilayered coating; and
transferring the multilayered coating onto the substrate to form a multilayer coating film, wherein
at least one of the first coating liquid and the second coating liquid comprises a mixing-preventing component that prevents mixing in the multilayered coating of the first coating liquid and the second coating liquid; and
molecules of the mixing-preventing component in the multilayered coating are localized toward a vicinity of an interface between the first coating liquid and the second coating liquid.

19. A multilayer coating film produced by the method of claim 1.
